(19) United States
(12) Patent Application Publication
(10) Pub. No.: US 2007/0185001 A1
(43) Pub. Date: Aug. 9, 2007

(54) Light low-dust, low-odor enzyme granules

(76) Inventors: Dieter Baur, Dusseldorf (DE); Lars Kucka, Essen (DE); Jens Van Holt, Kundl (AT); Udo Sturm, Nettetal (DE)

Correspondence Address: DANN DORFMAN HERRELL AND SKILLMAN, Suite 2400, 1601 Market Street, Philadelphia, PA, 19103-2307, US

(21) Appl. No.: 11/471,239

(22) Filed: Jun. 20, 2006

Related U.S. Application Data
(63) Continuation of application No. PCT/EP04/14286, filed on Dec. 15, 2004.

(30) Foreign Application Priority Data
Dec. 20, 2003 (DE) 103 60 841.9

(51) Int. Cl. C11D 3/00

(52) U.S. Cl. 510/392; 510/446

(57) ABSTRACT

An enzyme granule is made by a process comprising the steps of: (a) providing an aqueous enzyme concentrate; (b) contacting the concentrate with an ion exchange resin to decolorize and deodorize the concentrate; (c) adjusting the enzyme concentration in the concentrate from step (b); (d) forming enzyme granules from the concentrate from step (c). The granules are particularly suited for further processing, in particular, for blending into suitable formulations, such as, for example, in detergents or cleansing agents.

### CROSS REFERENCE TO RELATED APPLICATIONS

This application is a continuation under 35 U.S.C. § 365 and 35 U.S.C. § 120 of International Application PCT/EP2004/014286, filed Dec. 15, 2004. This application also claims priority under 35 U.S.C. § 119 of DE 103 60 841.9, filed Dec. 20, 2003. Each application is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention lies in the field of the fabrication of industrial enzymes. It relates to enzyme granules that originate from chromatographically and therefore gently decolorized and deodorized enzyme concentrates.

Important industrial fields of application for enzymes are inter alia detergents and cleansing agents and cosmetics. In these areas the enzymes per se represent the active agents in the products. In the fields of textile manufacture and textile conversion or in food production they serve mainly as auxiliaries to transform the raw materials into the actual product. Industrial enzymes are normally prepared in liquid form or in the form of solid granules, depending on the type of intended use.

A great number of different enzymes are established for use in detergents and cleansing agents, amylases, proteases, cellulases and lipases being of particular importance. Appropriate compositions are extensively described in the prior art. Exemplary appropriate uses of amylases are referred to in the following applications: WO 02/44350 A2 (for a cyclodextrin-glucanotransferase with α-amylase-activity); WO 02/10356 A2, WO 03/014358 A2, WO 03/002711 A2, WO 03/054177 A2, DE 10309803.8 A1 (α-amylases); DE 102004048590.9 and DE 102004048591.7 (α-amylase-containing automatic dishwasher agents; both unpublished so far). WO 96/34092 A2, WO 01/32817 A1 and WO 93/22414 A1 for example, relate to cellulases and cellulase-containing detergents and cleansing agents. WO 97/08281 A1, WO 95/27029 A1 and WO 97/41212 A1 for example, relate to lipases and lipase-containing detergents and cleansing agents. The following exemplary documents relate to proteases and the use of proteases in detergents and cleansing agents: WO 91/02792 A1, WO 92/21760 A1, WO 95/23221 A1, WO 03/038082 A2, WO 02/088340 A2, WO 03/054185 A1, WO 03/056017 A2, WO 03/055974 A2, WO 03/054184 A1, DE 102004027091.0, DE 10360805.2 and DE 102004019751.2 (the last three unpublished so far). For example, the application WO 98/55579 A1 describes that also two different proteases can be used side-by-side in detergents and even better in cleansing agents.

Enzymes are mostly produced by the fermentation of microorganisms and then purified out of the corresponding liquid media. Purification or enrichment processes for obtaining concentrated enzyme solutions are extensively described in the prior art. Techniques involving filtration, sedimentation or precipitation are mostly used for purification, wherein first the biomass is separated and then the enzyme concentrate is obtained by the use of increasingly more sensitive methods such as separation, micro filtration or ultra filtration.

(2) Description of Related Art, Including Information Disclosed Under 37 C.F.R. §§ 1.97 and 1.98

The application WO 01/37628 A2, for example, discloses a process for obtaining biotechnologically manufactured valuable substances from culture solutions and/or fermentation solutions, which includes the separation of water-insoluble solids from the aqueous solution that comprises the valuable substances, subsequent filtration of the resulting solution and concentration of the solution comprising the valuable substances by means of ultra filtration. It is characterized in that the separated solids are subjected to a washing step, in which the filtrate from the concentration step is used as the wash liquid.

Most refining methods are only suitable to an inadequate degree for removing denatured proteins and colored compounds from the enzyme concentrate separated from the biomass, or they also remove a large part of the stabilizing factors along with these. In all cases this results in an inadequate product quality. Then, either the enzyme concentrate has smears and/or particulates to the point of precipitated matter, or for clear solutions it possesses an inadequate enzyme stability. These disadvantages influence the products into which the relevant concentrate is incorporated, particularly the enzyme granules that result there from.

Processes for the decolorization and deodorization of concentrated enzyme solutions are also described in the prior art. Precipitation methods belong to these, for example, using organic solvents or polymers, in particular, however, salting out of the proteins of interest by means of sodium sulfate (described in H. Ruttloff (1994): “Industrielle Enzyme” Behr's Verlag, Hamburg, chapter 6.3.3.6, pages 376 to 379). The protein is precipitated in this way, whereas the accompanying materials remain in the supernatant liquid. However, a part of the protein is irreversibly denatured by the precipitation and resuspension and overall, the stability is impaired, not only because of this, but also because stabilizing compounds are separated out. The realizable yields are given as approximately 50% in the table on page 378 of this textbook.

A further alternative is the adsorptive purification of enzymes, for example, over an ion-exchange resin (H. Ruttloff (1994): “Industrielle Enzyme” Behr's Verlag, Hamburg, chapters 6.3.3.7 and 6.3.3.8, pages 379 to 396). For this the proteins of interest bind to a chromatographic material and are subsequently eluted with another medium. However, due to denaturation effects and folding effects, mostly only poor yields are achieved. Yields of about max. 60% are given in the table on page 378 for various chromatographic processes (except affinity chromatography). The specific, particularly the affinity chromatographic materials are generally more performant, but very sensitive and costly to manufacture. The latter are predominantly used in medicine, but practically not at all in industrial enzyme manufacture.

Examples of adsorptive purification of enzymes can be found in the patent literature, for example, in the publications WO 97/41212 A1 and WO 93/22414 A1. In the first of these two texts, many alkaline lipases are described that are suitable for use in detergents and cleansing agents. In many cases their preparation described therein includes chromatographic steps, whereby a fractionation by size is carried out by gel filtration and/or the enzymes of interest are bound to a column material by ion-exchange chromatography and subsequently eluted as the clean fractions and are thereby obtained in the essentially purified state. WO 93/22414 A1 describes detergent formulations comprising a mixture of various cellulase types. The latter are obtained by separating more complex cellulase mixtures using size fractionation by gel filtration and by fractionation by ion-exchange chromatography based on certain physico-chemical properties.

The reverse approach, aimed at depleting the contaminants from the liquid solution using a carrier material, is now only selected for foodstuff raw materials. Thus, the decolorization of sugars inter alia by sequential different ion-exchange chromatographical steps is described in the handbook “DIAION®. Manual of ion exchange resins and synthetic adsorbents, volume II” from the Mitsubishi Kasei Corp. (Tokyo, Japan), 2^{nd} edition, 1.5. 1993, pages 93 to 100. Fundamentally, the use of these reverse approaches results in several, each independently very selective, purification steps in which the respective contaminant remains on the appropriate material.

The so far unpublished application DE 10304066 also deals with the problem of freeing enzyme concentrates from solids, particularly irreversibly denatured proteins, and simultaneously decolorizing them—i.e. freeing them from the colored, mostly brown compounds that resulted from the previous sterilization of the constituents of the media from pre-fermentation—to conserve a highest possible storage stability of the concentrate. The latter, if possible, without also separating the factors that increase the stability of the proteins of interest. Consequently, to solve this object, a process for the enrichment of concentrated enzyme solutions was developed, characterized by the following steps:
(a) Providing a concentrated enzyme solution,
(b) Separating the solids, particularly the foreign proteins and/or inactive enzymes and
(c) Strongly basic anion exchange chromatography.

Additional processing provides inter alia, according to the invention, a mixture with additional solvents, for example, stabilizers. However, an additional conversion to solid granules is not precisely described in this application.

An extensive prior art also exists for methods of granulation. The most important of these methods are described in textbooks such as for example, the “Handbuch der Agglomerationstechnik” by G. Heinze (1999, Verlag Wiley-VCH, Weinheim, Germany, ISBN 3-527-29788-X, p. 65-170).

A large part of the patent literature also deals with coatings for enzyme granules. In some papers it is even proposed to apply the enzymes themselves as one layer among several. According to WO 93/07263 A2, for example, this fulfills a multiple purpose, namely inter alia a delayed release of the enzymes, a protection against external influences and at the same time a reduction in the quantity of enzyme dust that emanates from these particles However, the coloration or the odors of the coated enzymes are just as little discussed as the possible subject of masking them. The application WO 93/07260 A1 discusses the enzyme concentrates in question only in regard to their biophysical properties and proposes, for example, to add binders or powders in order to facilitate their further processing.

A process for manufacturing enzyme granules from enzyme solutions is proposed by the application WO 92/11347 A2. Accordingly, an additive that comprises 10 to 35 wt. % grain meal (based on the finished granule) is added to the concentrated fermentation broth. Moreover, an exterior coating that comprises colorant or pigment can be optionally deposited onto this type of granule to mask the inherent color of the granule. In the example, the layer is composed of titanium dioxide and polyethylene glycol and is deposited during the fluidized bed drying step. A possible decolorization or deodorization of the enzyme concentrate in question is not disclosed.

Similar enzyme granules that comprise a phosphated starch as the granulation auxiliary are disclosed in the application WO 97/40128 A1. A possible decolorization or deodorization of the enzyme concentrate in question is also not discussed here. Instead of this, it is again proposed to mask the inherent color of the enzyme concentrate in the granule with pigments. In the example, titanium dioxide, which adheres to the particles comprising mostly polyethylene glycol, is again used.

The object of the application WO 95/02031 A1 is cited, inter alia, as that of coating the inherent coloration of the non-encapsulated granule and of suppressing any possible smell by preventing the diffusion of the odorous materials. The solution to this is disclosed as an encapsulation system that comprises finely divided inorganic pigment, an alcohol or a mixture of alcohols with a melting point in the range 45-65° C., an emulsifier for the alcohol, a dispersion agent for the pigment and water.

The application WO 98/26037 A2 also specifically deals, in addition to an increased storage stability, with the problems of the inherent color of the enzyme concentrate as well as masking any possible disturbing odor of the granules. To this end, it provides an encapsulation system that comprises finely dispersed, water-insoluble pigment (for example, titanium dioxide), a room temperature-solid, water-insoluble organic material (for example, an ethoxylated fatty alcohol) and optionally a flow enhancer. Here, once again therefore, the unwanted properties are masked and the compounds that are the cause of these properties are not removed.

As emerges from these documents discussed here, for working up enzyme concentrates, on the one hand it is known to stabilize them and separate them from troublesome impurities. On the other hand, liquid enzyme concentrates are further processed to solid granules, for which it is deemed desirable, inter alia, to mask the odor and color of the resulting enzyme components, particularly by coatings. In contrast, however, so far it has not been considered to improve the color and odor of enzyme granules by making use of already suitably worked up enzyme concentrates. Possibly, the low degree of stability of all enzyme concentrates, decolorized and deodorized in the conventional way, also prevents this.

So far, there is no prior art intended for processing particularly gently worked-up enzyme concentrates into solid granules. In particular, their further processing, for example, by coating, and the properties of such coated granules have neither been disclosed nor proposed up to now.

The object is thus to provide a solid enzyme granule that is comparatively stable, is low in odor and has a pleasing color. This enzyme granule should be coatable or is coated, wherein the resulting coated enzyme granule has an equally light color as conventionally coated enzyme granules, but should tend to a lower dust formation under mechanical stress. Such an enzyme granule or such a coated enzyme granule is intended to be particularly suitable for blending into detergents and cleansing agents.

### BRIEF SUMMARY OF THE INVENTION

In order to achieve this object, a process for the manufacture of an enzyme granule from an aqueous, purified enzyme solution was invented comprising the steps of: (a) providing an aqueous enzyme concentrate; (b) contacting the concentrate with an ion exchange resin to decolorize and deodorize the concentrate in the concentrate from step (b); (c) adjusting the enzyme concentration; (d) forming enzyme granules from the concentrate from step (c).

### BRIEF DESCRIPTION OF THE DRAWING

FIG. 1 is a flow diagram of the process for preparing an enzyme granule, including the optional coating step.

### DETAILED DESCRIPTION OF THE INVENTION

The ion exchange chromatography in process step (b) effects a gentle decolorization and deodorization of the enzyme concentrate that in steps (c) and (d) is further processed to an enzyme granule. Such enzyme concentrates are, as is illustrated in the so far unpublished application DE 10304066, more stable than concentrates decolorized and deodorized in another manner. In this way, the present invention therefore also yields a higher stability for the granule. At the same time, the enzyme concentrates possess a lighter color through decolorization and weaker odor than the conventionally prepared enzyme concentrates. This benefits the granules derived therefrom insofar as they also exhibit an appealing, i.e. light color and a reduced odor.

In the case that the granules are subsequently coated, and then because of the inherent lighter color, less pigment needs to be added, such that these coated granules possess additional advantageous properties. In particular, this includes a lower dust formation under mechanical stress. Therefore, such granules are particularly suited for further processing, in particular, for blending into suitable formulations, such as, for example, in detergents or cleansing agents.

Accordingly, the subjects of the present invention are processes for the manufacture of enzyme granules, which are characterized by the cited steps, in particular, ion exchange chromatography. Optionally, a coating of these granules follows as step (e). Further subjects of the invention are the granules resulting from the inventive processes as well as compositions that comprise such granules, particularly detergents and cleansing agents.

These and further aspects of the present invention are presented in more detail below.

Processes involving the foregoing manufacture of process step (b) of an aqueous, purified enzyme solution are known to the person skilled in the art from the prior art and are generally described as downstream processing that occurs at the conclusion of fermentation and precede the fabrication. It serves to obtain substantially biomass-free, enriched aqueous enzyme solutions. As a rule, it encompasses a plurality of partial steps such as cell pulping, removal of the cell detritus, particularly by pelletizing, decanting and centrifuging steps. Also separation, micro filtration, ultra filtration or sterile filtrations, deodorization and the concentration, i.e. removal of the solvent to a mean concentration range of the enzyme, may already be used at this time or can be included as optional steps.

The optimal working range has to be determined individually for each enzyme, and not only in regard to the temperature, the pH and the ion strength, but in particular, in regard to the adjusted range of enzyme concentration before step (b). In particular, the enrichment should be controlled such that by a timely interruption of the concentration process, the resulting enzyme concentrate effectively exhibits no (quantitative) protein precipitation. According to the application DE 10304066, the optimal concentration range for the proteases from Bacillus lentus, studied therein, is 700 000 to 800 000 HPU/g. Above this range, the amount of precipitated solids soon increases over proportionally as a function of the activity and is accompanied by a dramatically increasing loss of useful product. A commercial rotary evaporator or a commercial thin layer evaporator, for example, can be used for a preceding concentration step.

It is advantageous, moreover, to adjust the enzyme solution to a suspension content or solids content of below 1 vol. %, as can be checked, for example, by centrifuging with a bench centrifuge for 10 minutes at 7000 g. Otherwise, disadvantageously, the losses in the following steps strongly increase. The removal of the precipitates (solids) formed in the concentration step applies in particular, to foreign proteins and/or inactive enzymes, particularly in the vicinity of the solubility product. This step is denoted as the separation. It is also carried out using known methods, for example, by means of a separator; in principle, filtration steps are also possible for this. An ultra filtration is also possible, as described, for example, in WO 01/37628 A2. Comparatively pure, low-solids enzyme solutions already enriched to a medium concentration value are obtained in this way.

In addition, the enzyme solution should be adjusted to a pH that is compatible with the enzyme and where it has a positive charge.

Step (b) together with the decolorization of the enzyme solution, previously purified by means of an anion exchanger (adsorber), represents the core of the invention. In this step, the colored impurities above all, more particularly the Maillard compounds, are adsorbed onto the resin, while the proteins, which are positively charged under appropriately selected conditions, are not bound to the resin by virtue of the strongly positive charge of the exchanger, but are obtained with the eluate in a substantially clear solution. Accordingly, step (b) represents a selective separation of the dyes from the concentrated enzyme solution, while the enzyme of interest and at least a part of the enzyme stabilizing factors remain in solution; from the chemical point of view, the latter are also mostly proteins.

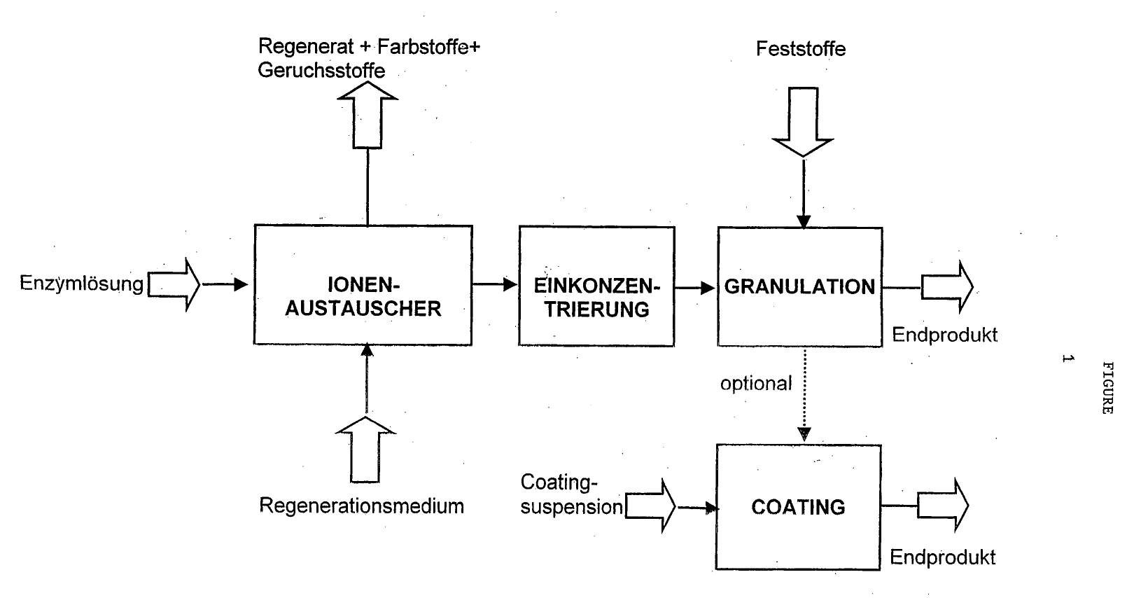

Formally speaking, this is therefore not a chromatography of the product, as the impurities to be separated, but not the product, are adsorbed on the chromatographic material. Therefore, one could also say that this is a type of filtration. However, as in fact a true chromatographic material has to be used and this also acts as a chromatographic material, namely in that it first binds materials and these are subsequently eluted on regeneration of the material, the method is most appropriately described by the term chromatography. It is particularly clear from FIG. 1 that the flow (the eluate) from the chromatography is used in the subsequent concentration step and thereby represents the useful product of interest, while the unwanted impurities, in particular, the colorants and odorous materials, are washed out in the regenerating liquid during the regeneration step.

The advantage of this process over the processes described in the prior art is that the useful materials in question, i.e., the enzyme proteins, remain in solution, i.e. do not have to be denatured and renatured, and hence are not modified in their three-dimensional structure. Accordingly, they also remain in the phase to be further processed and are not discharged from the system, so that the high yields mentioned above can be achieved.

As indicated in FIG. 1 by corresponding thick arrows, the predominantly colored substances bound to the resin are subsequently eluted in a separate step, i.e., after discharge of the useful material phase (of the useful product) and possible tailings. This is done, for example, with solutions of high ionic strength, for example, concentrated NaCl solutions. The anion exchange material can be regenerated by means of corresponding counterions, for example, NaOH. Other simple salts may be more suitable, depending on the chromatography material. The fact that this material can be treated with such compounds, which are also inexpensive, results in sterilization in addition to the purifying effect. The system is thus suitable for cleaning in place (CIP).

After process step (b), the liquid enzyme is substantially free from troublesome streaks, precipitates and dyes. It remains light, clear and bright, even in the event of prolonged storage at various temperatures, while at the same time having a high level of stability. The refined concentrated enzyme solution is clearly depleted, particularly in regard to the colored impurities, but still contains substantially colorless impurities, which are highly welcome by virtue of their partly stabilizing effect and which do not need, nor are intended, to be removed from the concentrated enzyme solution.

Additional intermediate steps may be carried out in advance, inserted, added on or carried out together with the steps mentioned, depending on the separation problem. Another possibility is, for example, to selectively remove other impurities from the concentrated enzyme solution by one or more additional chromatography steps, more particularly using other carrier materials. This may be done at any stage of the process that appears appropriate in each individual case, advantageously immediately before or after the chromatography step described in (a), optionally separated from one another by such intermediate steps as filtrations or re-solubilizations.

Possibilities for adjusting a suitable concentration according to step (b) are known to the person skilled in the art. In particular, the methods described above for the starting enzyme solution are applicable.

Also, processes to convert the enzyme solutions into solid granules according to step (c) are extensively described in the prior art. In general, they commence with a mixing of the enzymes with specific additives and yield particles. Such methods include, for example, fluidized bed granulation, mixing granulation in vertical mixers, counter current pelletizing mixers, Flexomix agglomerators, plowshare mixers or Ruberg mixers, roll granulation, for example, in rotary granulators or disc granulators, or molding granulators, carried out, for example, with presses, extruders or pressure roll machines. These techniques are described in text books such as for example, the “Handbuch der Agglomerationstechnik” by G. Heinze (1999, Verlag Wiley-VCH, Weinheim, Germany, ISBN 3-527-29788-X, p. 65-170).

A preferred process is disclosed, for example, in the European Patent EP 168526 B1, according to which the enzyme granules comprise water-swellable starch, zeolite and water-soluble granulation auxiliaries. The manufacturing process proposed therein essentially consists of concentrating the fermentation solution, freed beforehand of insoluble components, adding the cited additives, granulating the resulting mixture, and optionally encapsulating the granule with film-forming polymers and dyes. According to WO 92/11347 A2, enzyme granules, manufactured according to an alternative process, have favorable properties for the use in granular detergents and cleansing agents and comprise enzyme, swellable starch, water-soluble organic polymer as the granulation auxiliary, grain meal and some water. The composition of the additives makes possible the enzyme processing without any great loss in activity.

A favorable and thereby likewise preferred extrusion process that affords a highly soluble enzyme granule is described, for example, in WO 97/40128 A1, according to which the granules may contain a phosphated starch as the granulation auxiliary in addition to enzymes and carriers such as polyethylene glycol and/or polyethoxylate.

Further favorable embodiments of this subject matter of the invention follow from the realizations below.

In a preferred embodiment, the processes are characterized by an additional coating step (d).

Fundamentally, a coating of an essentially colorless and neutral smelling enzyme granulate also makes sense in order to protect the ingredients against external adverse influences. These include particularly moisture that can swell and destroy the particle and can activate the enzyme comprised in the particle, as well as the influence of oxygen that can lead to oxidative inactivation.

In principle, all types of coatings described in the prior art for enzyme particles and known to the person skilled in the art, are possible. Advantageously, the granules resulting from step (c) are first made into spheres, for example, in a Marumerizer, then the water content is reduced, for example, in a fluidized bed reactor and only then furnished with a protective layer. The last step can be carried out, for example, in conventional mixers, for example, from the Lödige Company (Germany) or in the fluidized bed.

Such processes include those in which a protective layer is applied over a so-called melt coating. Thus, a polymer, for example, a polymeric alcohol together with an emulsifier for this polymer, are deposited, advantageously together with a pigment that lends the resulting coated particle its color. Such a process is described, for example, in WO 95/02031 A1, particularly for use in detergents and cleansing agents. White titanium dioxide is preferably used as the pigment.

An alternative preferred process, according to which no solvent is added and has to be removed again after the coating, follows, for example, from the application WO 98/26037 A2. According to this, a fine, inorganic, water-insoluble pigment, optionally together with a flow enhancer and an organic substance with a melting point of 40-70° C., are deposited. This coating is also particularly suitable for particles that are subsequently mixed into detergents and cleansing agents.

Preferred processes are characterized in that in step (b) an anion exchange chromatography is carried out, preferably with a material that exhibits a maximum exchange capacity in the pH range 5 to 11 and particularly preferably in the range 6 to 8. All whole numbered and non-whole numbered values between these numbers are included.

The core of the inventive process is therefore constituted by a rather basic to strongly basic anion exchange chromatography with step (b). Under these conditions, the mostly colored impurities are adsorbed onto the material while the positively charged proteins, however, are not. Due to the fact that most natural, water-soluble, in particular, secreted proteins are water-soluble at rather medium pH values, it is particularly advantageous not to choose extremes but rather only a weakly basic to neutral pH range.

Alkaline proteins in particular, such as for example, the enzymes secreted by alkaliphilic microorganisms, in particular, proteases, have an isoelectric point in the alkaline range and are therefore positively charged in the preferred pH range in which the ion exchanger works most efficiently, and hence do not bind to the particulate material. An ideal pH for this process has to be experimentally determined for each protein and adjusted with regard to this step (b). In Example 1 this value was 7.5 for the chosen alkaline protease. For the individual case, an anion exchanger is therefore selected whose maximum exchange capacity is in agreement with the IEP of the enzyme in question.

Preferred anion exchange chromatographic processes are characterized in that the anion exchanger for step (b) contains quaternary ammonium groups as functional groups, preferably those substituted by at least two alkyl groups and particularly preferably those substituted by at least two alkyl groups with one or two carbon atoms and optionally in addition by a hydroxyalkyl group with one or two carbon atoms.

They have proved to be particularly suitable for step (b) by virtue of their chemical properties. The binding capacity for the particularly colored impurities and the non-binding of the enzymes of interest are critical and are to be optimized for individual cases.

In addition, such anion exchange chromatographic processes are preferred, wherein the anion exchanger for step (b) comprises trimethylammonium or dimethylethanolammonium groups as the functional groups. The latter is a little more weakly basic than the former, so that in particular, this variation can be optimized for the respective proteins.

In addition, preferred processes are those wherein the anion exchange chromatography is carried out in a pH range of 5 to 9, preferably from 6 to 8.5, particularly preferably from 7 to 8. All whole numbered and non-whole numbered values between these numbers are included. This complies with the above statement in relation to the isoelectric point of the (preferably alkaline; see below) enzyme and the chosen matched optimal working range of the ion exchanger.

Preferred processes are those wherein the ion exchanger for step (b) has an exchange capacity of 0.7 to 1.2 meq/ml, preferably 0.8 to 1.1 meq/ml and particularly preferably 0.9 to 1.0 meq/ml. All whole numbered and non-whole numbered values between these numbers are included.

The exchange capacity, which is expressed in mol equivalents per unit volume, indicates how densely the material is occupied by the functional groups. The given ranges were found empirically to be advantageous, in particular, for Example 1 of the present application, and depend on how high the concentration of the quantitatively difficultly determinable impurities in the enzyme solution is. Suitable working ranges have to be determined experimentally on a case by case basis and particularly depend on how much of these impurities have already been separated along with the higher molecular weight compounds in the preceding steps.

Preferred processes are those wherein the ion exchanger for step (b) has effective pore sizes of 0.2 to 0.7 mm, preferably 0.3 to 0.6 mm and more preferably 0.4 to 0.5 mm. All whole numbered and non-whole numbered values between these numbers are included.

Here as well, the range is determined empirically and particularly depends on the size of the enzyme being purified and the purity of the enzyme solution. The more the higher molecular weight compounds remaining, the easier the column is blocked up and if anything a large pore size material should be avoided. On the contrary, the separation power increases with increasingly smaller pores. Therefore, suitable working ranges have also to be determined experimentally case by case. For the protease with a molecular weight of approximately 27 kD investigated in the example, a chromatographic material with an effective pore size of 0.45 mm was found to be expedient. For significantly larger or smaller proteins, the chromatographic material should be selected with correspondingly larger or smaller effective pore sizes.

Preferred processes are those wherein the ion exchange resin beads for has a particle size distribution of 150 to 3,000 μm, preferably 175 to 1,500 μm, and particularly preferably, from 200 to 800 μm. All whole numbered and non-whole numbered values between these numbers are included.

Here as well, the range is determined empirically according to Example 1 and has to be checked experimentally case by case and optionally adjusted.

Preferred processes are those wherein the ion exchanger for step (b) is based on a porous plastic polymer, preferably a styrene-DVB copolymer.

In principle, suitable carriers for strongly basic anion exchangers to be used in accordance with the invention are any of the materials described for this purpose in the prior art including, for example, gel-form carriers. By contrast, strongly basic anion exchangers based on a porous polymer are preferred for step (b) by virtue of their technical properties. Strongly basic anion exchangers based on a styrene/DVB copolymer have proved to be particularly advantageous. Such materials are inert to attack from impurities, for example, practically inaccessible to hydrolytic enzymes and are robust towards the subsequent regeneration steps that can be carried out, for example, with NaOH.

Chromatography materials having the properties just discussed are described in detail in the prior art. Those from the DIAION®) series are described, for example, in the manual “DIAION®, Manual of ion exchange resins and synthetic adsorbent, Vol. 1,” Mitsubishi Kasei Corp. (Tokyo, Japan), June 1995, pp. 104 to 108 and in “Product Line Brochure DIAION®” 1.6.2001, pp. 4 to 6, which is obtainable from the manufacturer or from Summit Chemicals Europe GmbH, Düsseldorf, Germany. Strongly basic anion exchangers described there include the series DIAION® SA, DIAION® PA and DIAION® HPA. One representative, namely DIAION® PA308L, was successfully used in Example 1 of the present application.

Chemically similar materials which may be used can be produced by relevant experts in accordance with the foregoing observations on preferred properties or may also be obtained from other commercial manufacturers and likewise characterize preferred embodiments. Comparable results are obtained, for example, with the materials DOW MSA Marathon® from Dow Chemicals and Amberlite® 900CL from Rohm & Haas.

Besides the material, the processing conditions are also critical for the success of the inventive chromatography. These include in particular, a certain bed volume, which is the ratio by volume of the added solution to that of the column, and a certain residence time, which is expressed by the amount of enzyme per g of material and unit time.

Therefore, preferred processes are those wherein the chromatography in step (b) is carried out with a bed volume ratio of 0.1 to 100, preferably from 0.5 to 40, particularly preferably from 1 to 4. All whole numbered and non-whole numbered values between these numbers are included.

These bed volumes represent the optimum, experimentally determined in Example 1 for keeping the filtrate as clean, and at the same time as concentrated as possible. Depending on the properties of the material and the enzyme being purified, they have to be individually determined on a case by case basis.

In addition, processes are preferred wherein the average residence times for the chromatography in step (b), are values of 0.01 to 2 g, preferably 0.025 to 0.1 g, particularly preferably 0.04 to 0.06 g and quite particularly preferably 0.05 g enzyme per g ion exchange material per minute. All whole numbered and non-whole numbered values between these numbers are included.

This thermodynamic value describes the separation process and was shown to be optimal in Example 1. Depending on the properties of the material and the enzyme being purified, it has to be individually determined on a case by case basis.

Particularly suitable processes are those that are controlled substantially automatically.

In addition, such processes are preferred wherein the chromatography in step (b) is controlled by the conductivity of the eluate, in particular, for the separation between forerun and useful product and/or useful product and tail.

A control method that is particularly easy to incorporate is based on determining the conductivity (measurable as pS/cm) of a processed material at critical places and using the results to control the process. Thus, the transition from the forerun to the useful product and its end can be detected from the corresponding changes in conductivity. Each of the liquid streams are then appropriately transferred by means of a suitable control unit.

In addition, such processes are preferred, wherein the chromatography in step (b) is realized by recycling at least a part of the forerun and/or tails from the ion exchange chromatography into the enzyme solution prior to the chromatography.

It has already been proposed in patent application WO 01/37628 A2 to use the filtrate for an additional washing step. In this way, the fraction in question is additionally enriched with enzyme molecules that had still not been washed out from the column towards the end of the peak. This step is limited in principle by the possible impurities that are possibly washed out from the column. In each individual case, a balance has to be struck between the obtainable concentration and product quality, i.e. purity.

Preferred processes are those wherein the adjustment of a suitable concentration in step (b) is realized by concentrating the enzyme solution.

The enzyme solution after step (b) may be possibly very highly concentrated, such that additional solvent must be added to adjust a concentration suitable for step (c). In general, however, the solution is rather too strongly diluted as the separation efficiency of the chromatography and the overall obtainable yield of the useful product depend on an optimal dilution. Therefore, a concentration of the enzyme solution is preferred. In this regard however, according to the invention, it has less to do with precipitations and redissolution in a smaller volume, because, as discussed previously, the wanted accompanying substances would also be lost. In fact, processes are preferred, in which only the volume of the solvent present after the chromatography is reduced. Such processes are known from the prior art and have already been presented earlier as the preparation for step (b). A commercial rotory evaporator or a commercial thin layer evaporator, for example, can also be used for these steps. They are controllable by the respective apparatus parameters and the respective reaction times.

Preferred processes are those wherein the concentration in step (b) is realized with a concentration ratio of 1.01 to 10, preferably from 1.1 to 8, particularly preferably from 1.2 to 4, each based on the associated volumes. All whole numbered and non-whole numbered values between these numbers are included.

This degree of concentration can be calculated from the ratio of the starting volume of the chromatographic solution to that of the concentrated solution. To a certain extent, this step represents a preparation for the subsequent granulation, in which further water is removed. Therefore, the aimed end volume as well as the subsequently itemized parameters are not only based on the concentration of the enzyme solution after the chromatography, but also on the requirements of the final granulation step (c). They must eventually be optimized according to the experience with those relevant to the equipment used for the granulation. This is common practice for the person skilled in the art.

In addition, those processes are preferred, wherein the dry substance-content at the start of the concentration in step (b) is 0.1 to 40 wt. %, preferably from 0.5 to 20 wt. %, particularly preferably from 1 to 15 wt. %. All whole numbered and non-whole numbered values between these numbers are included.

This similarly empirically optimizable value depends in the first instance on how the chromatography is realized. It is critical that they result in an optimal separation. The subsequent step is to be adjusted to this. Should the dry substance-content be close to or significantly under the lower limit, then the concentration can be carried out in two consecutive steps and optionally with two different processes or differently working equipments.

In addition, those processes are preferred, wherein the concentration is realized thermally.

In addition, those processes are preferred, wherein the thermal concentration of the enzyme solution in step (b) is realized at 5 to 70° C., preferably from 10 to 60° C., particularly preferably from 20 to 40° C., quite particularly preferably at 35° C., each based on the associated vapor pressure. All whole numbered and non-whole numbered values between these numbers are included.

The value that is simply set for each of the equipment units particularly complies with the properties of the prepared enzyme. High temperatures accelerate the process, but generally have a deleterious effect on the enzyme. An optimal value has to be determined empirically. In the example of the present application, approximately 35° C. under approximately 50 mbar proved to be advantageous for the preparation of a subtilisin.

Among the inventive processes, those are preferred, wherein the dry substance-content at the end of the adjustment of the suitable concentration in step (b) is 8 to 50 wt. %, preferably 9 to 40 wt. %, particularly preferably 10 to 35 wt. %. All whole numbered and non-whole numbered values between these numbers are included.

This value determines the biophysical properties of the enzyme mash, for example, the viscosity or the miscibility with the subsequently added compounds and the eventual resulting dilution of this, and is therefore decisive for the success of the subsequent granulation step. The choice of the respective granulation system thereby determines the optimal dry substance-content and has to be experimentally determined on a case by case basis. Possible variations also result from the choice of process, for example, thin layer evaporation or ultra filtration. For the latter a characteristic upper limit may not be exceeded.

Among the inventive processes, those are preferred, wherein the viscosity of the concentrate in step (b) is adjusted to 1 to 1,000 mPas, preferably 1 to 500 mPas, particularly preferably 1 to 200 mPas. All whole numbered and non-whole numbered values between these numbers are included.

According to the above statements this value particularly depends on the requirements of the subsequent granulation.

Among the inventive processes, those are preferred, wherein said processes comprise a protease, whose activity in step (b) is adjusted to 200,000 to 2,000,000 HPU per g concentrate, preferably 500,000 to 1,500,00 HPU, particularly preferably 800,000 to 1,200,000 HPU per g concentrate. All whole numbered and non-whole numbered values between these numbers are included.

So far, enzymes have been discussed that are prepared according to the invention. Enzymes represent preferred embodiments because, on the one hand, they are of particular industrial interest. Nonetheless, this process may be applied to any water-soluble proteins providing suitable solvent systems and chromatography materials can be found for them and suitable detection reactions can be established. This applies, for example, to peptides, for example, peptide hormones, pharmacologically significant oligopeptides, and to antibodies. Antibodies would also be suitable, for example, for detection. All these proteins are intended to be understood as enzymes in the context of the present invention.

However, technically useful enzymes in the conventional sense are the focus of interest, preferably a hydrolase or an oxidoreductase and more preferably a protease, amylase, cellulase, hemicellulase, lipase, cutinase or a peroxidase. They are respectively preferred depending on the importance of each of their fields of application, in so far as for the purpose of the application they can be advantageously added in the form of solid granules. Proteases and amylases, for example, as they are described for liquid use in the application DE 10304066, belong to this group. Among these, proteases are preferred, as they are the most important enzymes for detergents and cleansing agents. Moreover, the successful preparation of a protease granule is described in the example of the present application.

The proteolytic activity (given in HPU) can be measured as follows according to the method described in Tenside 7 (1970), 125 by means of a discontinuous determination using casein as the substrate: The concentrations of the substrate solution were 12 mg per ml casein (manufactured according to Hammarsten, supplier: Merck, Darmstadt, No. 2242) and 30 mM Tris in synthetic tap water (aqueous solution of 0.029% (wt/vol) CaCl₂*2H₂O, 0.014% (wt/vol) MgCl₂*6H₂O and 0.021% (wt/vol) NaHCO₃ with a hardness of 15 degrees dH (German hardness). The substrate solution was heated to 70° C. and the pH adjusted to pH 8.5 with 0.1 N NaOH at 50° C. The protease solution was prepared with 2% (wt/vol) anhydrous pentasodium tripolyphosphate in synthetic tap water, the pH being adjusted to 8.5 with hydrochloric acid. To 600 μl casein solution were added 200 μl of the enzyme solution. The mixture was incubated for 15 minutes at 50° C. The reaction was ended by adding 600 μl 0.44M trichloroacetic acid (TCA) 0.22M sodium acetate in 3% (v/v) acetic acid. After cooling on ice for 15 minutes, the TCA-insoluble protein was separated by centrifugation, an aliquot of 900 ml was mixed with 300 μl NaOH, and the extinction of this mixture that contained TCA-soluble peptides was taken at 290 nm. Control values were prepared by adding 600 μl of the TCA solution to 600 μl casein solution followed by 200 μl enzyme solution. According to the definition, a protease solution that produces an extinction coefficient of 0.500 OD at 290 nm, under these experimental conditions, has an activity of 10 Pu per ml.

The concentration adjustment depends on which activity the granules obtained from step (c) or (d) should have. For use in detergents and cleansing agents, a final activity of approximately 1,000,000 HPU/g has proven advantageous; concentration to this content was also made in Example 1.

Additional ingredients can be added to the enzyme preparation, particularly during the course of the concentration adjustment. As solid enzyme preparations also tend to denature in storage and thereby lose their activity, it is advantageous, particularly at this time, to add a stabilizer mixture. Such compounds are known per se from the prior art. They include, for example, compounds which develop a stabilizing effect, for example, against temperature variations, biophysically through regulation of the water activity, such as polyols, among them preferably glycerin or particularly preferably 1,2-propanediol, and compounds that reversibly deactivate proteases, particularly boron-containing or boric acid-containing protease inhibitors, or which afford protection against oxidation. The last named compounds include, for example, reducing agents, antioxidants and transition metal compounds. They are advantageously added in liquid form in order to ensure a solution and/or an optimal mixing. The water can be removed again at a later time (see below).

Even more ingredients can be added prior to the granulation if the intended field of use requires them. For example, for use in granules in detergents and cleansing agents, these include surfactants, builders, perfumes or further ingredients. Thus, for example, in application of WO 98/50511 A1, it is also advantageous to already blend into the granule cyclodextrin, whose precursors or derivatives are color transfer inhibitors

Among the inventive processes, those are preferred, wherein the granulation in step (c) is carried out by extrusion. This process, with equipment that is advantageously used in it, has already been presented above. The use of a twin-screw extruder is particularly advantageous and is used in the example of the present application. The resulting, generally still moist extrudate can then be conveyed to a dryer, for example, into a fluidized bed dryer (see below). If the granulation is carried out from the start in a fluidized bed dryer, then the conveying step is avoided. This extrusion affords granules that are shelf stable and that simultaneously show a favorable dissolution behavior which is particularly beneficial for use in detergents and cleansing agents.

Among the inventive processes, those are preferred, wherein the granulation in step (c) is adjusted in such a way that it results in an average particle size of 100 to 10,000 μm, preferably from 200 to 5,000 μm, particularly preferably from 400 to 1,000 μm from the extrusion, particularly according to the size of the holes in the die plate or the speed of the knives. All whole numbered and non-whole numbered values between these numbers are included.

The size of the resulting particles is determined particularly according to the field of application. For example, for use in detergents and cleansing agents, the requirements of a mechanical stability and the fastest possible dissolution in the wash liquor have to be particularly considered. Optimal sizes have to be determined experimentally and can be obtained from the granulation regulation systems that are known to the person skilled in the art.

Among the inventive processes, those are preferred, wherein the granulation in step (c) occurs by mixing the enzyme concentrate from step (b) with one or a plurality of ingredients, selected from the group of grain meal, starch, starch derivatives, cellulose, cellulose derivatives, lubricants (plasticizers), sugars and enzyme stabilizers.

The inventively preferred mixtures for the granulation have already been listed with reference to relevant publications. The composition of the ingredients determines the physical properties of the resulting granules or coated particles. These include the mechanical stability and the rate of dissolution, which critically depends on how fast water penetrates into the capillaries of the particle, thereby triggering its destruction. This is controlled, for example, by the use of swellable and/or soluble compounds. All these compounds per se are known from the prior art. In particular, polyols such as, for example, polyethylene glycol or polyvinyl alcohol serve as lubricants (plasticizers). Some solvent can optionally be added for this lubricant and is advantageously removed during the subsequent drying. The sugars include primarily mono or oligosaccharides or their mixtures; saccharose was used in the example of the present application.

Among the inventive processes, those are preferred, wherein the granules obtained in step (c) are dried.

As mentioned above, this can be carried out by conveying into other equipment or when possible in the same equipment, in which the granulation took place. The purpose of this is that an enzyme preparation, particularly from hydrolytic enzymes, is generally the more stable, the less water is present. On the other hand, included water accelerates an intended dissolution process of the particles during the end-use.

Several advantageous embodiments of the optional step (d) have already been described above.

Such particularly advantageous and correspondingly preferred processes with step (d) are wherein the coating in step (d) is realized with
0 to 30 wt. % pigment,
0 to 30 wt. % plasticizer,
5 to 97.5 wt. % film-former (flow agent) and optional further ingredients.

As a result of the present invention and as also substantiated in Example 1, the granules obtained according to (c) exhibit a lighter color and a lower odor than conventional granules. Therefore, in specific cases, a coating can be completely dispensed with; otherwise a thinner coating is generally sufficient, in particular, with less pigment. This is particularly true for a coating with a white pigment. In this way, the properties of the particle, such as the elasticity, in particular, the surface properties such as the rate of dusting, are influenced more by the usual coating components. Advantageously, the granules with less pigment form less fines and consequently produce a lower dust impact. In addition, there is a financial effect, as less raw material is required.

The example of the present invention demonstrated that a coating of polyethylene glycol 20,000 and 6 to 20 wt. % titanium dioxide was particularly advantageous. Known commercial equipment for this purpose can be employed for coating; in the present example it was a Topspray fluidized bed coater.

At the same time, the stabilizers already listed above, can also be added as optional ingredients. Moreover, it is advantageous and therefore correspondingly preferred, if additional substances are added which are beneficial to the later end-use of the granules. As mentioned above, for use in detergents and cleansing agents, these include surfactants or builders, for example. A further example of this is found, for example, in WO 95/17493 A1, in which is disclosed the addition of silver corrosion inhibitors, bleaching agents and/or bleach activators, particularly for the subsequent incorporation in automatic dishwasher compositions.

In addition, such processes are preferred, wherein the coating comprises 2.5 to 27.5 wt. %, advantageously 5 to 25 wt. % pigment. All whole numbered and non-whole numbered values between these numbers are included.

These ranges were substantiated, in particular, for a white pigment, in the example of the present application.

In addition, such processes are preferred, wherein the coating comprises 0.5 to 15 wt. %, advantageously 1 to 5 wt. % plasticizer. All whole numbered and non-whole numbered values between these numbers are included.

This value depends particularly on the flowability of the film-former under the set conditions. However, according to the invention it is therefore lower than is normally found in the prior art, as the flowability automatically increases with a lower content of brittle, dry pigment.

In addition, such processes are preferred, wherein the coating comprises 7.5 to 95 wt. %, preferably 10 to 90 wt. %, particularly preferably 20 to 80 wt. % film-former. All whole numbered and non-whole numbered values between these numbers are included.

Moreover, among these, such processes are preferred, wherein the thickness of the coating is 1 to 15 μm, preferably 5 to 50 μm, particularly preferably 10 to 30 μm. All whole numbered and non-whole numbered values between these numbers are included.

In general, the coating thickness according to the invention can therefore be less than the typical values seen up to now, because a substantial amount of pigment can be dispensed with. Thus, the coating described in Example 1, consisting of approximately 80 wt. % PEG and approximately 20 wt. % titanium dioxide has an average coating thickness of approximately 20 μm.

In accordance with the above statements, such processes are preferred, wherein a technically applicable enzyme, preferably a protease, particularly preferably an alkaline protease, is incorporated in step (b).

In accordance with the above statements, such processes are preferred, wherein the granule obtained in step (d) comprises, particularly as a result of the control of the granulation in step (c), an average particle size of 110 to 5,000 μm, preferably from 200 to 2,000 μm, particularly preferably from 400 to 1,200 μm. All whole numbered and non-whole numbered values between these numbers are included.

These values are somewhat greater than those obtained according to (c), and should be adjusted, however, according to the granule specifications. It should be kept in mind that the coating also makes a contribution to the elasticity and constitutes a protection for the ingredients.

In accordance with the above statements, such processes are preferred, wherein a protease is incorporated in step (b) and the granule obtained in step (c) or (d) comprises, particularly as a result of the control of the concentration in step (b), an average activity of 50,000 to 500,000 HPU/g, preferably from 100,000 to 200,000 HPU/g, particularly preferably from 140,000 to 380,000 HPU/g. All whole numbered and non-whole numbered values between these numbers are included.

Consequently, these values are favorable, for example, for the relevant control of the protease concentration in different detergent formulations.

An enzyme granule that is obtained by one of the previously described processes and which consequently exhibits favorable properties constitutes a separate subject of the invention.

An agent comprising such an enzyme granule constitutes a further separate subject of the invention.

According to the invention, an agent is understood to mean each composition or formulation that comprises such a granule as the active component. Its normal composition is determined by the field of use of the agent. Accordingly, it is therefore particularly advantageous to use inventively coated granules, because additional ingredients are present in such compositions, which could endanger the inventive granule or contained enzyme with respect to their stability.

These are understood to mean all relevant required compositions or formulations corresponding to the prior art, for example, liquid, preferably anhydrous formulations, in which the appropriately coated inventive granules are stable. The stability can be controlled in particular, by the ionic strength and the presence of water scavengers and/or builders.

In a preferred embodiment, however, the agent is overall in solid form, preferably in powder form or compacted, here particularly preferably compacted into tablets.

The stability of tablets towards dissolution processes is less critical than for liquid formulations. Their manufacture has been known for a long time in the prior art.

In a preferred embodiment, it is a detergent or a cleansing agent.

Accordingly, this embodiment of the invention also includes all the various possible types of cleansing compositions-both concentrates and compositions to be used without dilution-for use on a commercial scale in washing machines or in hand washing or cleaning. These include, for example, detergents for fabrics, carpets or natural fibers, for which the term “detergent” is used in the present invention. These also include, for example, dishwashing detergents for dishwashing machines or manual dishwashing detergents or cleansers for hard surfaces, such as metal, glass, china, ceramic, tiles, stone, painted surfaces, plastics, wood or leather, for which the term “cleansing agent” is used in the present invention. Any type of detergent or cleansing agent represents an embodiment of the present invention, providing it is enriched by an enzyme granule manufactured according to the invention.

Embodiments of the present invention include all types established by the prior art and/or all required usage forms of the inventive detergents or cleansing agents. These include, corresponding to the above statements, particularly solid, powdered, agents optionally also from a plurality of phases, compressed or non-compressed; further included are for example: extrudates, granulates, tablets or pouches, both in bulk and also packed in portions. Liquid, paste-form or gel-form embodiments are also included providing the enzyme granule processed in accordance with the invention can be maintained stable therein.

Both detergents and cleansing agents for commercial use, as well as those with the presentation form and the choice of ingredients particularly conceived for consumers, are also included therein.

In a preferred embodiment, the inventive detergent or cleansing agents comprise active enzymes in an amount of 2 μg to 20 mg, preferably 5 μg to 17.5 mg, particularly preferably 20 μg to 15 mg, quite particularly preferably 50 μg to 10 mg per gram of the agent. All whole numbered and non-whole numbered values between these numbers are included.

Besides an enzyme granule prepared in accordance with the invention and possibly other enzymes, a detergent or cleansing agent according to the invention optionally contains other ingredients from the prior art such as, for example, enzyme stabilizers, surfactants, for example, non-ionic, anionic and/or amphoteric surfactants, bleaching agents, bleach activators, bleach catalysts, builders, solvents, thickeners and—optionally as further typical ingredients—sequestering agents, electrolytes, optical brighteners, redeposition inhibitors, color transfer inhibitors, foam inhibitors, dyes and/or perfumes, antimicrobial agents and/or UV absorbers, to mention only the most important classes of ingredients. Such compositions are extensively described in the prior art.

To be able to realize this aspect of the invention, reference is particularly made to the following, already cited documents, in which such detergents and cleansing agents are extensively illustrated. Examples of the relevant use of amylases are: WO 02/44350 A2 (for a cyclodextrin-glucanotransferase with oc-amylase-activity); WO 02/10356 A2, WO 03/014358 A2, WO 03/002711 A2, WO 03/054177 A2, DE 10309803.8 A1 (α-amylases); DE 102004048590.9 and DE 102004048591.7 (α-amylase-containing automatic dishwasher agents; both unpublished); examples of cellulase-containing detergents and cleansing agents are: WO 96/34092 A2 and WO 01/32817 A1; examples of lipase-containing detergents and cleansing agents are: WO 97/08281 A2 and WO 95/27029 A1; and examples of protease-containing detergents and cleansing agents are: WO 91/02792 A1, WO 92/21760 A1, WO 95/23221 A1, WO 03/038082 A2, WO 02/088340 A2, WO 03/054185 A1, WO 03/056017 A2, WO 03/055974 A2, WO 03/054184 A1, DE 102004027091.0, DE 10360805.2 and DE 102004019751.2 (the last three unpublished).

The following examples further exemplify the present invention.

### EXAMPLES

### Example 1

Manufacture of a Protease Granule.

Step (a): Preparation of an Aqueous, Purified Enzyme Solution.

Firstly, a concentrated protease solution was prepared by working up a supernatant fermentation liquid of protease-forming and protease-secreting gram positive bacteria. For this, the series of points described in Example 1 of the application DE 10304066 was followed: “biomass separation,” “determination of the optimal working range,” “step (a): concentration of the enzyme solution to the working range” and “step (b): separation of the resulting precipitates (solids).” This resulted in 10 l of a protease solution with an activity of 750,000 HPU/g and a dry substance content of 25 wt. %. Their appearance according to the internationally accepted CIE-LAB color scale, defined in DIN 5033-3 and DIN 6174, exhibited an L-value (brightness) of 60, an a*-value (red-green) of 3.0 and a b*-value (yellow-blue) of 60.

Step (b): Ion Exchange Chromatography.

There followed a strongly basic anion exchange chromatography, carried out at pH 7.5. It was carried out in a fixed bed using a strongly basic anion exchanger of the DIAION® Pa 308 L type obtainable from Mitsubishi, Tokyo, Japan or from Mitsubishi Chemical Europe GmbH, Düsseldorf, Germany. 2.5 l of this was prepared in a glass column equipped with a sieve plate; the bed height was 300 mm; the geostatic height served as the driving force. The chromatography was effected with regard to the bed volume ratio (BV: ratio by volume of the enzyme concentrate to the resin) and the residence time. In practice, a ratio of 2 to 5 BV and a dosage of 0.05 kg enzyme solution per kg resin per minute were set. This was carried out by gravity flow.

The separation principle is based on the enzyme being repelled by the carrier material and entrained into the liquid stream, while the accompanying substances are adsorbed onto the immobile carrier. In order to increase the yield, part of the tails was passed through the column again. Then, the compounds adsorbed onto the column (in particular, the dyes and odorous substances), were then washed out by flushing with NaCl and NaOH solutions, thus regenerating the fixed bed.

In this way, 15 l of a weakly colored protease concentrate were obtained. Its activity was 490,000 HPU/g (yield 98%, based on the initial activity). A CIE color value of L=92, a*=1.5 and b*=20 was determined.

Step (c): Adjustment to a Suitable Concentration.

The thermal-concentration technique was selected for adjusting the concentration of the protease concentrate obtained from step (a). The enzyme solution was concentrated down to a final activity of approximately 1,000,000 HPU/g by means of a commercial rotary evaporator (Rotavapor, Büchi, Switzerland) at approximately 35° C. and approximately 50 mbar.

Step (d): Granulation.

Granulation was carried out by means of the extrusion method. To the concentrated protease solution resulting from step (b), were added in a batch mixer (Lödige Company) the following commercial additives: maize starch, wheat meal, PEG 2,000 (BASF, Germany) cellulose, saccharose.

This mixture was directly extruded in a commercial counter-rotating twin-screw extruder (Lihotzki Company, Germany) and the resulting, still moist extrudate was then gently dried, i.e. below 40° C., in a fluidized bed drier (WSG 5, Glatt Company, Germany).

The resulting granules were very light colored and had practically only the inherent coloration of the solid raw material. The CIE-color values were determined as L=81, a*=2 and b*=15, while a similarly treated comparative granule, not subjected to step (a) but deodorized in the conventional manner, exhibited L=67, a*=4 and b*=18.

Step (e): Coating.

The granules obtained from step (d) were then coated with an aqueous suspension of PEG 20,000 (BASF) and titanium dioxide of the rutile type (Huntsman, Great Britain). A commercial Topspray fluidized bed coater (WSG 5, Glatt Company) was used and a temperature of less than 40° C. was maintained. The resulting coating consisted of approximately 80 wt. % PEG and approximately 20 wt. % titanium dioxide and had an average layer thickness of approximately 20 μm.

The CIE color values for the resulting coated granules were measured as L=82, a*=1 and b*=8, while the comparative granules already used in step (c) and then subjected in the same way to step (d) had values of L=76, a*=2 and b*=8.

On repeating the experiment, the titanium dioxide content of the coating of the inventive granules could be lowered to approximately 6 wt. %, the obtained color values being still no worse than those of the comparative granules.

1. A process for the manufacture of an enzyme granule comprising the steps of: (a) providing an aqueous enzyme concentrate; (b) contacting the concentrate with an ion exchange resin to decolorize and deodorize the concentrate; (c) adjusting the enzyme concentration in the concentrate from step (b); (d) forming enzyme granules from the concentrate from step (c).

2. The process of claim 1 further comprising the step of coating the granules formed in step (d).

3. The process of claim 1, wherein the ion exchange resin is an anion exchange resin having a maximum exchange capacity in the pH range 5 to 11.

4. The process of claim 1, wherein the ion exchange resin is comprised of quaternary ammonium functional groups as the functional groups having at least two alkyl groups.

5. The process of claim 1, wherein the quaternary ammonium functional groups are trimethylammonium or dimethylethanolammonium groups.

6. The process of claim 1, wherein step (b) is carried out in a pH range of from 5 to 9.

7. The process of claim 1, wherein the exchange capacity of the ion exchange resin is from 0.7 to 1.2 meq/ml.

8. The process of claim 1, wherein the pore size of the ion exchange resin is from 0.2 to 0.7 mm.

9. The process of claim 1, wherein the particle size distribution of the ion exchange resin beads is from 150 to 3000 μm.

10. The process of claim 1, wherein the ion exchange resin is based on a porous styrene-DVB copolymer.

11. The process of claim 1, wherein the bed volume of the resin is from 0.1 to 100.

12. The process of claim 1, wherein the average residence time for step (b), is from 0.01 to 2 g of enzyme per g ion of exchange material per minute.

13. The process of claim 1, wherein step (b) is controlled by the conductivity of the eluate.

14. The process of claim 1, wherein in step (b) at least a part of the forerun and/or tails from the ion exchange chromatography into the enzyme solution prior to the chromatography.

15. The process of claim 1, wherein step (c) is carried out by concentration.

16. The process of claim 14, wherein step (c) is carried out a concentration ratio of from 1.01 to 10 based on the associated volumes.

17. The process of claim 14, wherein the dry substance-content at the start of the concentration in step (c) is from 0.1 to 40 wt. %.

18. The process of claim 14, wherein the concentration is realized thermally.

19. The process of claim 17, wherein the temperature of the concentration is from 5 to 70° C.

20. The process of claim 17, wherein the dry substance-content at the end of the adjustment in step (c) is from 8 to 50 wt. %.

21. The process of claim 1, wherein the viscosity of the concentrate in step (c) is from 1 to 1000 mPas.

22. The process of claim 1, wherein when the enzyme is a protease the activity in step (c) is adjusted to 200 000 to 2 000 000 HPU per g concentrate.

23. The process of claim 1, wherein step (d) is carried out by extrusion.

24. The process of claim 1, wherein step (d) is carried out such that the average particle size of the granules is from 100 to 10 000 μm.

25. The process of claim 1, wherein the granulation in step (d) is carried out by mixing the enzyme concentrate from step (c) with an ingredient selected from the group consisting of grain meal, starch, starch derivatives, cellulose, cellulose derivatives, lubricants (plasticizers), sugars and enzyme stabilizers.

26. The process of claim 1 further comprising the step (e) of drying the granules formed in step (d).

27. A process for the manufacture of an enzyme granule comprising the steps of: (a) providing an aqueous enzyme concentrate; (b) contacting the concentrate with an ion exchange resin to decolorize and deodorize the concentrate; (c) adjusting the enzyme concentration in the concentrate from step (b); (d) forming enzyme granules from the concentrate from step (c); (d) coating the granules from step (c).

28. The process of claim 26, wherein the coating in step (d) is comprised of from 0 to 30 wt. % pigment, from 0 to 30 wt. % plasticizer and, from 5 to 97.5 wt. % film-former (flow agent).

29. The process of claim 26, wherein the coating comprises from 2.5 to 27.5 wt. % pigment.

30. The process of claim 27, wherein the coating comprises 0.5 to 15 wt. % of a plasticizer.

31. The process of claim 27, wherein the coating comprises from 7.5 to 95 wt. % of a film-former.

32. The process of claim 26, wherein the coating thickness is from 1 to 150 μm.

33. The process of claim 1, wherein the enzyme is an alkaline protease.

34. The process of claim 1, wherein the particle size of the granule obtained in step (d) is from 110 to 5,000 μm.

35. The process of claim 32, wherein the average activity of the enzyme concentrate in step (c) is from 50,000 to 500,000 HPU/g.

36. An enzyme granule obtained by a process of claim 1.

37. A detergent or cleansing agent comprising enzyme granules of claim 35.

38. The agent of claim 36, wherein the enzyme granules are in the form of a tablet.
